(19) United States
(12) Patent Application Publication
(10) Pub. No.: US 2016/0026979 A1
(43) Pub. Date: Jan. 28, 2016

(54) Adaptable Application Platform For Adapting To Day-To-Day Tasks

(71) Applicant: Bala R. Vatti, Hudson, NH (US)

(72) Inventor: Bala R. Vatti, Hudson, NH (US)

(21) Appl. No.: 14/804,549

(22) Filed: Jul. 21, 2015

Related U.S. Application Data
(60) Provisional application No. 62/027,580, filed on Jul. 22, 2014.

(51) Int. Cl. G06Q 10/10; G06Q 10/06

(52) U.S. Cl. CPC G06Q 10/1097; G06Q 10/06315; G06Q 10/06316

(57) ABSTRACT

The invention pertains to a system and method for an adaptable application platform developed with the concept of a system adapting to people's day-to-day tasks, as opposed to people adapting to many disjoint solutions that were developed to address specific problems. The invention is based on reducing the tasks people perform into a small set of basic tasks and implementing these tasks on the platform along with the necessary support functionality. This allows users to develop their specific solutions and interact with others over the platform using a simple common interface without any programming knowledge or special skills.

The present application claims priority to U.S. Provisional Patent Application Ser. No. 62/027,580 for “Adaptable Application Platform”, filed Jul. 22, 2014, the disclosure of which is incorporated by reference.

### FIELD OF THE DISCLOSURE

This invention relates to a computer software application running on a network of computers such as the Internet. In particular, the invention presents a novel deviation from the traditional problem-centric approach used in offering solutions designed around specific problems, which has significant drawbacks as outlined below.

### BACKGROUND

Current applications such as Amazon, EBay, YouTube, Expedia, Odesk offer solutions to specific problems through their central platforms or websites, and the users conceptually gather around the platforms and trade their products or services by connecting to the platforms. This problem-centric model has the following drawbacks:
1. In this model, the use of the platform to the users is limited to the specific solution each platform offers.
2. We are forced to constantly switch between websites offering specific solutions.
3. We are also forced to learn and adapt to these solutions.
4. Solutions are scattered and are hard to find.
5. Many services are not available to common people, either they are too expensive, too complicated with technical jargon or proprietary in nature. Some are designed for high-level executives, technical people, planners, etc.
6. We end up using multiple accounts, managing different accounts and passwords.
7. Solutions don't work well together, which means we can't combine applications to receive their combined benefit.
8. There are also functional gaps in the available solutions, and as a result it becomes necessary to manually fill the gaps by the users. Typically, one needs multiple services and a lot of manual work in between to complete a task.
9. These solutions do not support the multiple roles we play in our lives.
10. The solutions are not designed for organizing and managing users' own tasks.
11. Our ability to connect, share and apply information creatively is compromised.

Because of the above reasons there is a need for a solution centered abound users or user-centric, which adapts to users day-to-day tasks and allows users to form networks of communities around them.

### SUMMARY

This invention discloses a solution that overcomes above drawbacks and allows users to develop specific solutions using a common interface over the platform without any programming skills.

By providing an application platform that adapts to the way people work and live, the platform satisfies the needs of the people with superior functionality, system expandability, reduced cost and improved flexibility.

The system adapts to users by supporting day-to-day tasks of what people naturally do. A person's tasks can be classified or reduced as: (1) items produced, (2) items consumed (3) working with others, usually in groups possibly with some working relationships and (4) converting or transforming the items consumed to Items produced using some process. Items consumed and produced can be either goods or services.

Examples of items produced include: speaking/writing, offering/selling goods, offering services, showing a movie, cooking, making arts/crafts, teaching lessons, sending a message, and the like.

Examples of consumed items include: listening/reading, buying goods, hiring services, watching a movie, eating/drinking, receiving arts/crafts, taking lessons, reading a message, and the like.

A basic element of the system is an entity, which is a software representation of a person, a group of people, a business, an organization or an institution. The system supports the above three classifications of tasks.

Entities can also be formed by other entities, and a basic entity that is not formed by other entities may represent a person. That is, when a person is represented as an entity in the system, it becomes a basic entity. When an entity represents something other than a person, it can be a basic entity or a non-basic or a complex entity. A complex entity manages one or more of other entities.

The system allows formation of managing and managed entities to facilitate formation of management structures as in business and organizations, allowing expansion of entities vertically.

An entity can organize some or all other entities it is associated with into various groups for efficiency and convenience. The entity can configure groups with various properties including privileges, privacy and other properties as needed.

Groups differ from complex entities in that complex entities are formed by any combination of basic entities (e.g., a person) and other complex entities. Items produced and consumed are internally tied to a complex entity so there will be net produced and consumed items for the complex entities as seen externally. For example, a company or corporation can be a complex entity. As a whole, the company or corporation consumes certain products and services and produces certain products and services, yet it is formed internally by different entities including officers, administrators, and support staff. In contrast, a group can be a group of entities formed for convenience due to some functional relationship. For example, all suppliers can be in a group, and all consumers can be in another group.

The system supports a flexible, selectively shareable calendar and a selective portions of which can be merged with calendars of other entities to provide necessary functionality between entities for performing various tasks.

The system provides a task scheduler to entities to execute tasks (or service requests) in isolation, in series or in parallel with other tasks by allowing various pre and post task execution conditions.

The system offers a flexible and convenient process management functionality to entities for setting up processes which convert or transform its consumed items to produced items or from its inputs to outputs. This process can be used from simple operations like reselling and cooking to complex manufacturing operations. This allows to track time, cost, and resources used for the entities' operations.

The system also provides material management functionality to compute material requirements, material cost, and generation of alerts upon shortages or excess production. These can also be computed at any intermediate production stages.

The system offers bookkeeping functionality for computing various parameters over specific time periods. These include quantities of items used, cost of items, production or consumption sorted by entities, and more.

The system offers flexible and effective search mechanism for finding producers and consumers of an item and allows the entities to connect and exchange goods and services.

### BRIEF DESCRIPTION OF THE DRAWINGS

FIG. 1 is a graphical illustration of a list of consumed items and a list of produced items, of a basic entity representing a person;

FIG. 2 is a graphical illustration of a network of basic entities (persons) exchanging items;

FIGS. 3A, 3B, and 3C are graphical illustrations showing how the same items can be produced from the same consumed items using different processing structures inside a complex entity;

FIG. 4A is a graphical illustration of a management structure within a complex entity;

FIG. 4B is a graphical illustration of an entity hiding its internal details as there would be no difference for external interactions;

FIG. 5 is graphical illustration of a network of entities including both basic and complex entities, using the same interface;

FIG. 6A is a graphical illustration of a person (basic entity) categorizing his/her connections as different groups for convenience;

FIG. 6B is a graphical illustration of a complex entity also categorizing its connections as different groups for convenience;

FIG. 7 is an illustration of user interface for creating a user account or user login;

FIG. 8A is an illustration of user interface for produced items;

FIG. 8B is an illustration of user interface for consumed items; FIG. 9 is an illustration of user interface for entity groups;

FIG. 10 is an illustration of a user interface for activity reports;

FIG. 11A is an illustration of a user interface for searching;

FIG. 11B is an illustration of a user interface for a search item view details;

FIG. 12 is an illustration of a task scheduler user interface;

FIG. 13 is an exemplary user interface as webpage showing entities organized as bookmarks;

FIG. 14 is an illustration of operations performed on multiple calendars;

FIG. 15A is a flowchart for finding and adding a consumed item;

FIG. 15B is a flowchart for adding a produced item;

FIG. 16A is a flowchart for creating a management structure;

FIG. 16B is a block diagram of a management structure;

FIG. 17A is an entity process graph illustrating process steps from consumed items to produced items;

FIG. 17B is an exemplary user interface for process steps;

FIG. 18 is an overview of the system components;

FIG. 19 shows an exemplary software architecture;

FIG. 20 shows an exemplary logical data model of the system;

FIG. 21 shows an exemplary sequence diagram of submitting form data;

FIG. 22 shows an exemplary sequence diagram of notification subscription;

FIG. 23 shows an exemplary sequence diagram of updating status of a goods or service;

FIG. 24 shows an exemplary sequence diagram of triggering mechanism for timed tasks; and

FIG. 25 shows an exemplary sequence diagram of event bus processing.

### DETAILED DESCRIPTION

The present application discloses an invention which is substantially different from the previously issued U.S. Pat. No. 8,515,831 titled “Peoples' task management framework” by the same inventor, Bala Vatti. This patent discloses an invention whereby users can form entities representing individuals, groups of people, businesses, organizations and institutions, and share or trade products and services by defining them as produced and consumed items primarily as external interactions by adopting a novel people centric approach. The current patent application discloses an invention that primarily describes a system of building processes that transform or convert consumed items to produced items within an entity and how entities can be attached to the processes of the entity. This system can be used by common people as well as other entities to manage their day-to-day tasks in a networked environment. The process can send alerts and notifications to external entities for smooth operations.

In particular, the present invention is directed to more than simply a software platform. The invention discloses a new adaptable goods and services exchange platform with a novel interface for creating from simple to complex processes and workflows. In contrast to prior art platforms, such as typical e-commerce websites which require an administrator or other third party to create and display content, the present invention adopts a novel people centric approach which allows for individual users to create, search for, and receive as well as offer goods and services without the need of an intermediary. This approach allows formation of networks of communities around users and manage their day-to-day tasks. In addition to finding items of interest, users can also find entities of interest for social or professional interactions.

Practical applications include the following examples: Finding people of common interests like tennis players and scheduling matches.

A small pizzeria owner setting up the process, connecting with his/her suppliers and customers and automatically tracking and ordering ingredients as orders come in from the customers.

A knitting hobbies connecting with yarn suppliers and sharing ideas with co-hobbyists and others, which may evolve to become a profitable business as the word spreads.

A plumbing business allowing its customers to order work, setup appointments with its plumbers and track their progress.

A piano player sharing her expertise with the neighbors by setting up music sessions.

A bicycle maker ordering parts from suppliers, setting up assembly process with some employees and supplying to the customers.

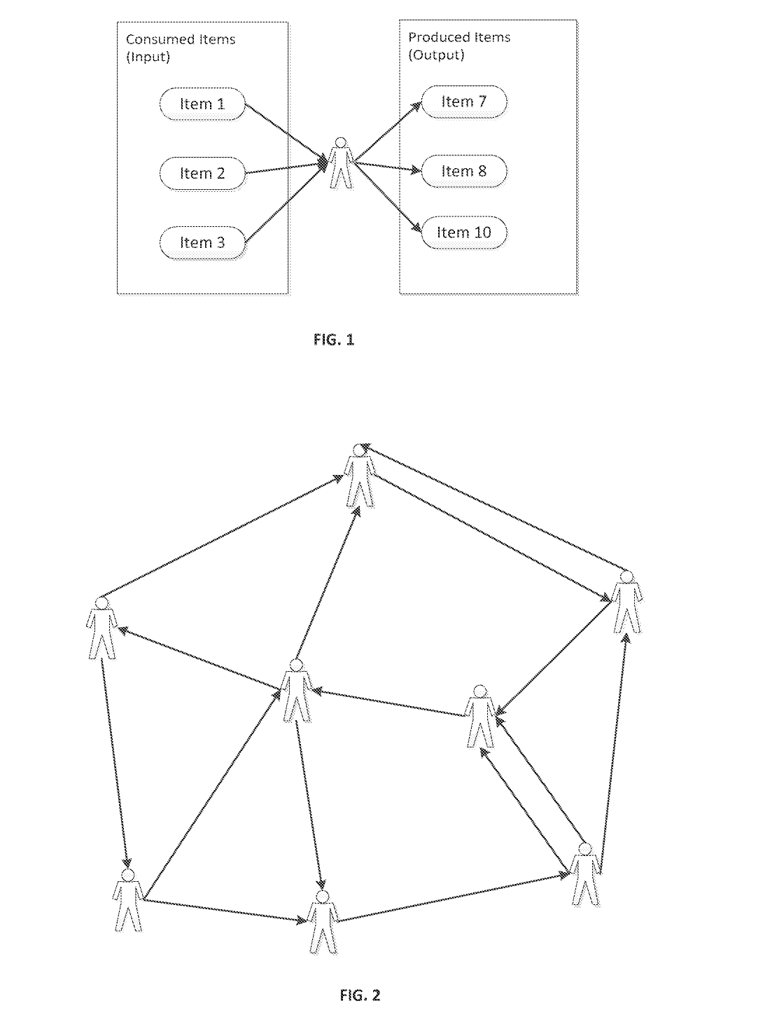

FIG. 1 shows how a person's tasks can be classified as produced items (output) or consumed items (input). An item can be goods or a service.

FIG. 2 shows how a network of people can connect and exchange matched items in a flat network.

However, by nature, people work with others in order to achieve anything significant. When a group of people work together, the group can be treated as an entity and all tasks this group performs can also be classified as items produced and items consumed from an external point of view.

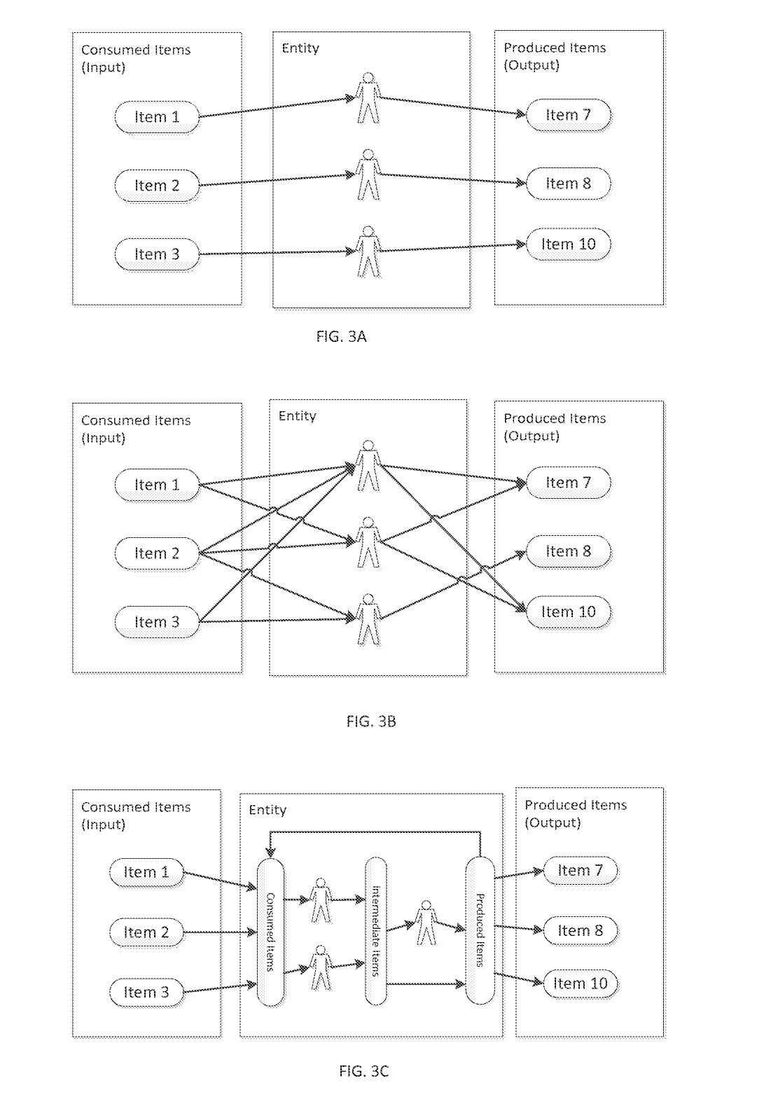

FIG. 3a shows a scenario where the inputs are exclusively distributed to the group members and outputs are also exclusively produced by the members. All the people would be working independently here.

FIG. 3b shows a scenario where the inputs are non-exclusively distributed among the members and the outputs are also created non-exclusively by the group members.

FIG. 3c shows a scenario where the inputs are distributed to a set of people of the group and produce a first stage or an intermediate stage output, which then is processed by the remaining group member or members to produce the final output. This figure also shows some of the final output may also be used by the group members. There could be other possible scenarios where the inputs and outputs are distributed and processed differently.

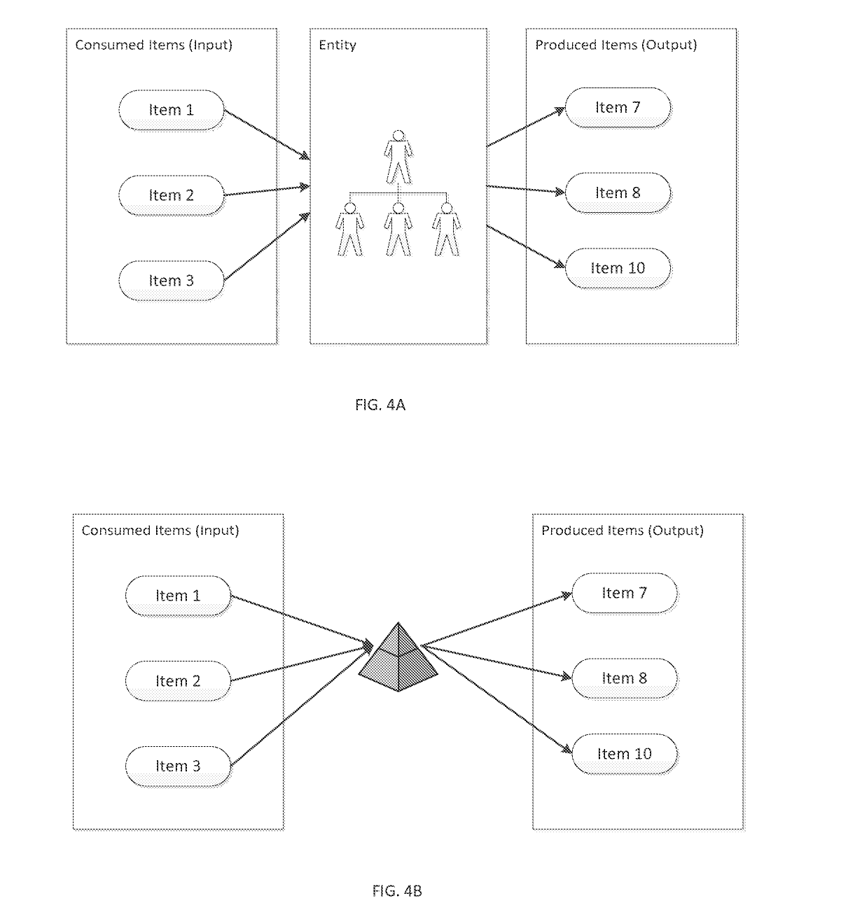

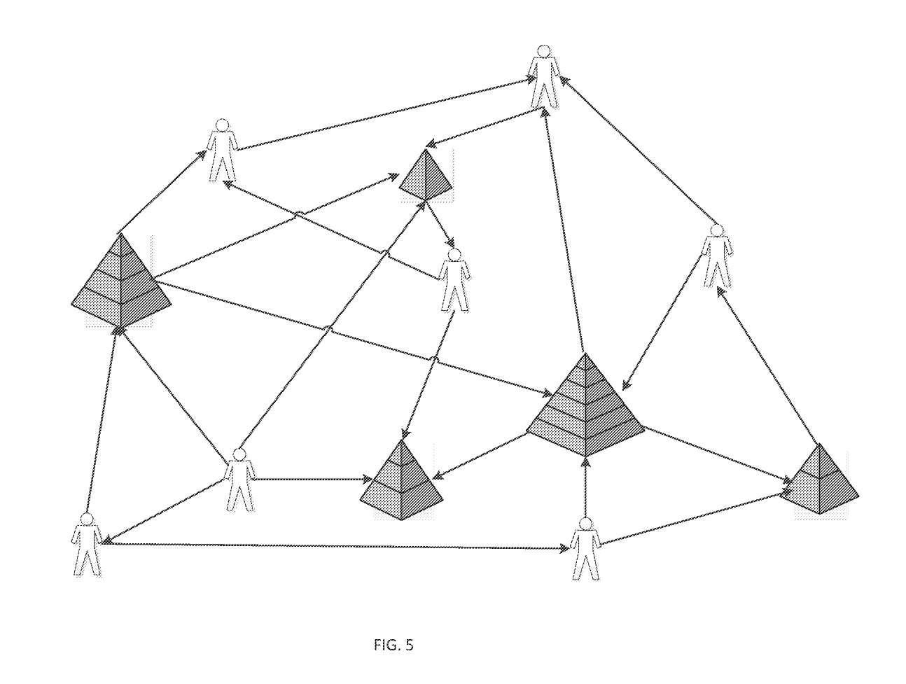

FIG. 4a shows a scenario where a simple management structure in which one manager manages three other people and this team, as a whole, takes the input and produces the output. From an external point of view there is no difference in the way the entity is interacted with externally regardless of how the group is internally organized or how they interact to produce the output.

Hence, isolating the internal structure from an external point of interaction makes it possible to define an entity as a representation of a person, a group, a business, an organization or an institution. Inputs and outputs can be matched and exchanged the same way, regardless of the entity's internal structure.

An entity can be a manager or a managed entity. An entity can be a managed entity (similar to an employee) if it contributes its services to a manager entity. Typically, a manager entity provides the inputs to the managed entities, and uses the managed entities' outputs to form the manager entity outputs.

By forming entity structures as described above, entity networks can grow infinitely both horizontally and vertically.

FIG. 4b shows an entity as a pyramid. Horizontal slices on the pyramid indicate levels in the management. However, there is no difference the way other entities connect and interact with an entity, regardless of its management levels.

FIG. 5 shows a network of entities involving people and organizations with different level management structures.

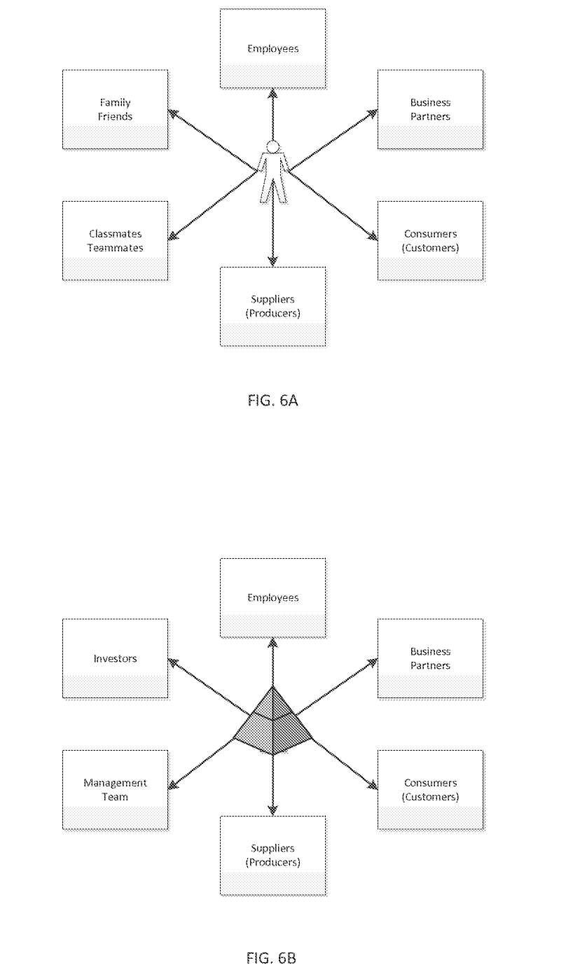

FIG. 6a shows how a person works with other people by categorizing them into groups based on functions or other characteristics as needed.

FIG. 6b shows how an entity, like a person, can also be working with other entities by categorizing them into groups based on functions or other characteristics as needed.

In addition to producing and consuming items, a person naturally works with groups for fun, social, or functional interactions. The ability of the system to provide group interactions, as an individual or as an organization, results in an useful platform for users.

Common web browsers could be used to present a user interface of the platform with multiple tabs for performing frequently used functions. Each tab may contain user interface elements such as buttons, menus, form fields, etc.

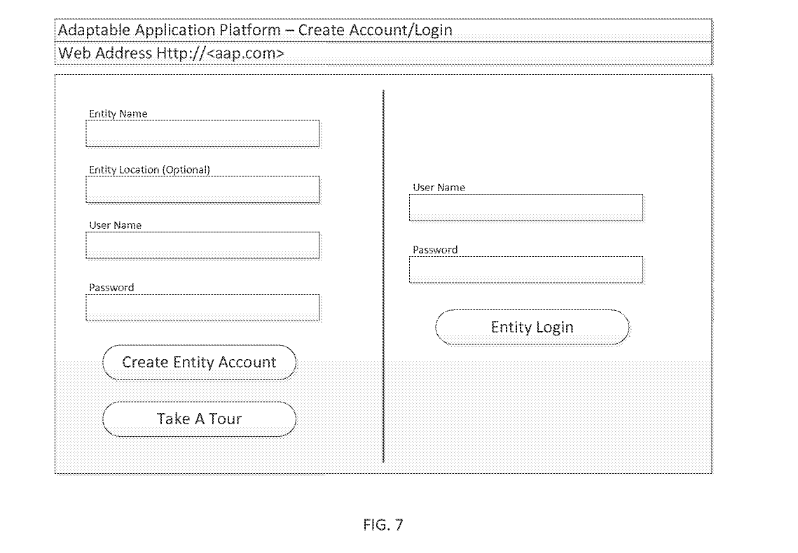

FIG. 7 shows an example view of the entity Create/Login window for of the system. This allows users to create an entity account and allows them to login. Optionally, this view also allows new users to explore the features of the platform by clicking the “Take A Tour” button.

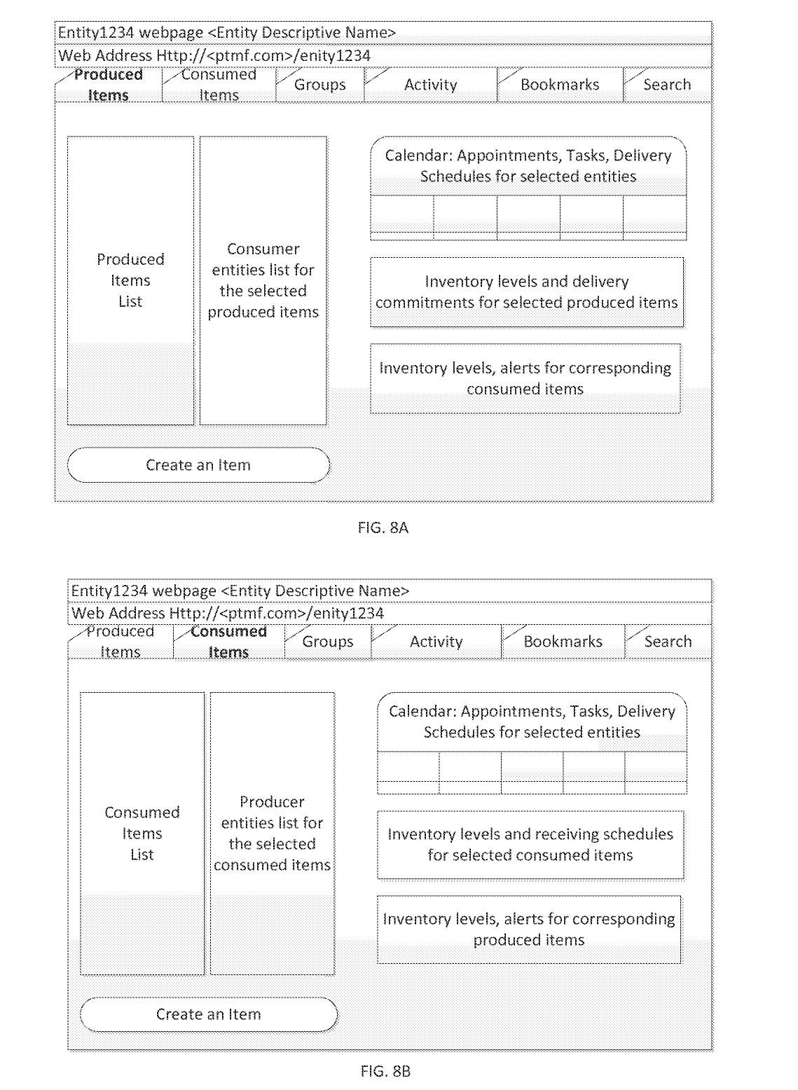

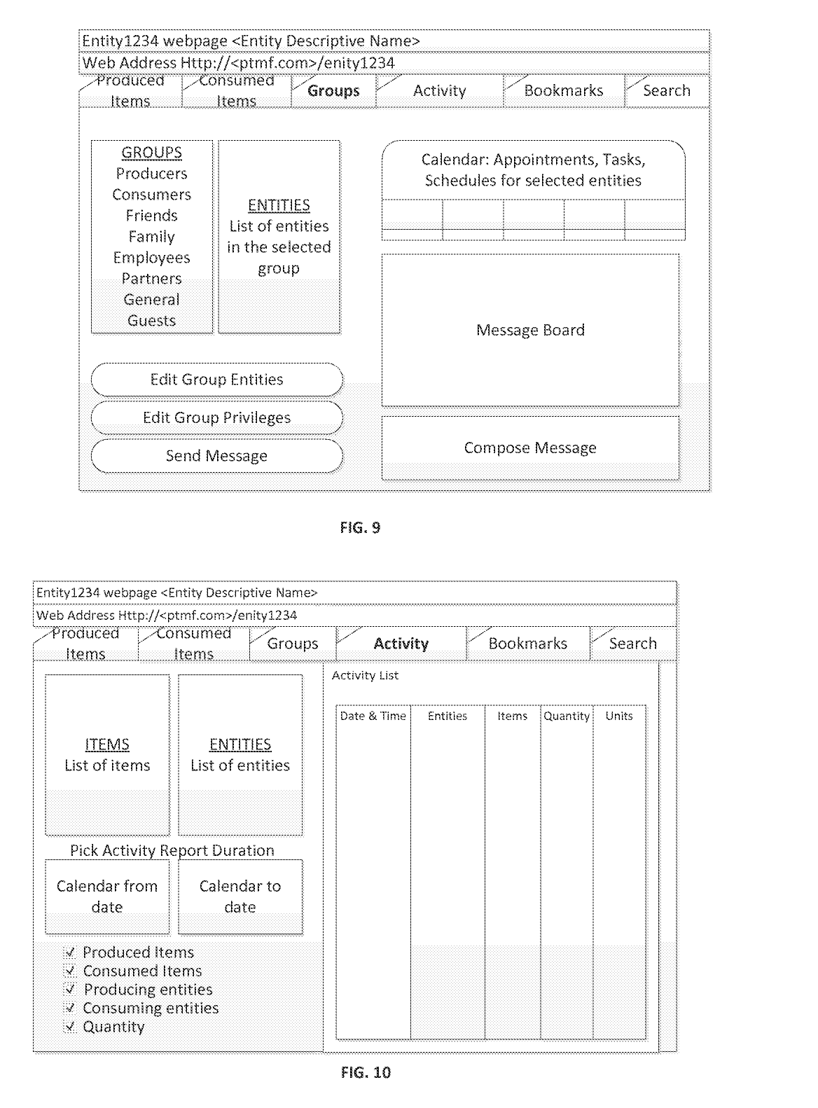

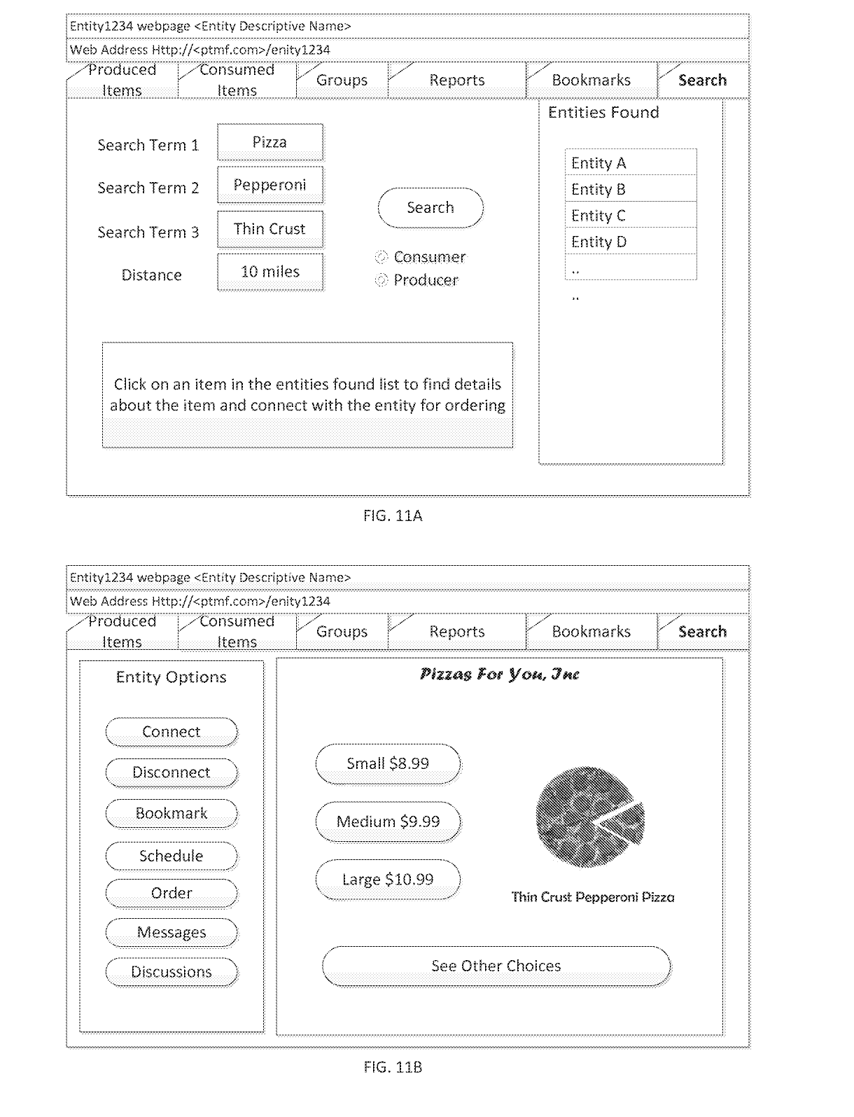

After logging in the system, the user is presented with a set of tabbed windows. FIG. 8A shows an exemplary view of the Produced Items tab of the platform. This view shows a list of produced items of the entity and the consumer entities of the selected produced items. A Calendar view shows appointments, tasks and delivery schedules for the selected entities in the list. It also shows important status indicators for the selected items including inventory levels, delivery commitments, corresponding consumed items, inventory levels, etc. The “Create an Item” button takes to a window for creating a produced item.

FIG. 8B shows a view of the Consumed Items tab of the platform for managing the consumed items and interacting with the entities that are producing these items. This view includes a list of consumed entities and producing entities list of selected consumed items. This will enable interaction with the producing entities. This view also shows a Calendar view containing delivery schedules for selected items and appointments with producing entities. In addition, this also contains inventory levels for corresponding produced items and consumed items, as well as any alerts for these items. This also shows a button for creating consumed items which opens another window for searching producing entities and interacting with them.

FIG. 9 shows a view of the Groups tab to configure and interact with groups. The Groups list shows all the configured groups for the entity. The Entities list shows the entities of a selected group. A Calendar view shows tasks, schedules, and appointments for the entities. The Message board shows the group or individual entity messages. Compose Message and Send Message are used to send messages to an entity or a group of entities.

FIG. 10 shows a view of the Activity tab for the entity. Items, as well as entities associated with the items, can be selected, and additional options, as shown, can be selected to zoom in on the activities of interest. This can also be used for bookkeeping, business analysis, and reporting.

FIG. 11A shows a view of the Search tab for searching producing and consuming entities of an item using suitable key words and other search criteria. The user can also select if the results should include producers or consumers. The search returns a list of entities and the user can click on entities from the list to learn the details of the item and for further interaction. If the user decides to, then the user can connect with the entity and transact as needed. The connection can be dropped by any of the entities if it is no longer needed or desired. Buttons are also provided for bookmarking, ordering, scheduling orders, exchanging messages with the producing/consuming entity and reading/commenting on a message board regarding the item.

FIG. 11B shows a view of the entity details selected from the search list. Unlike the current web links presented from the search engines which take the users to their respective websites for further interaction, the target entity details are presented within the entity's own account, and further interactions can be performed from the entity's known environment. There is no learning curve involved related to the target link. Entity can perform all the operations from his or her account.

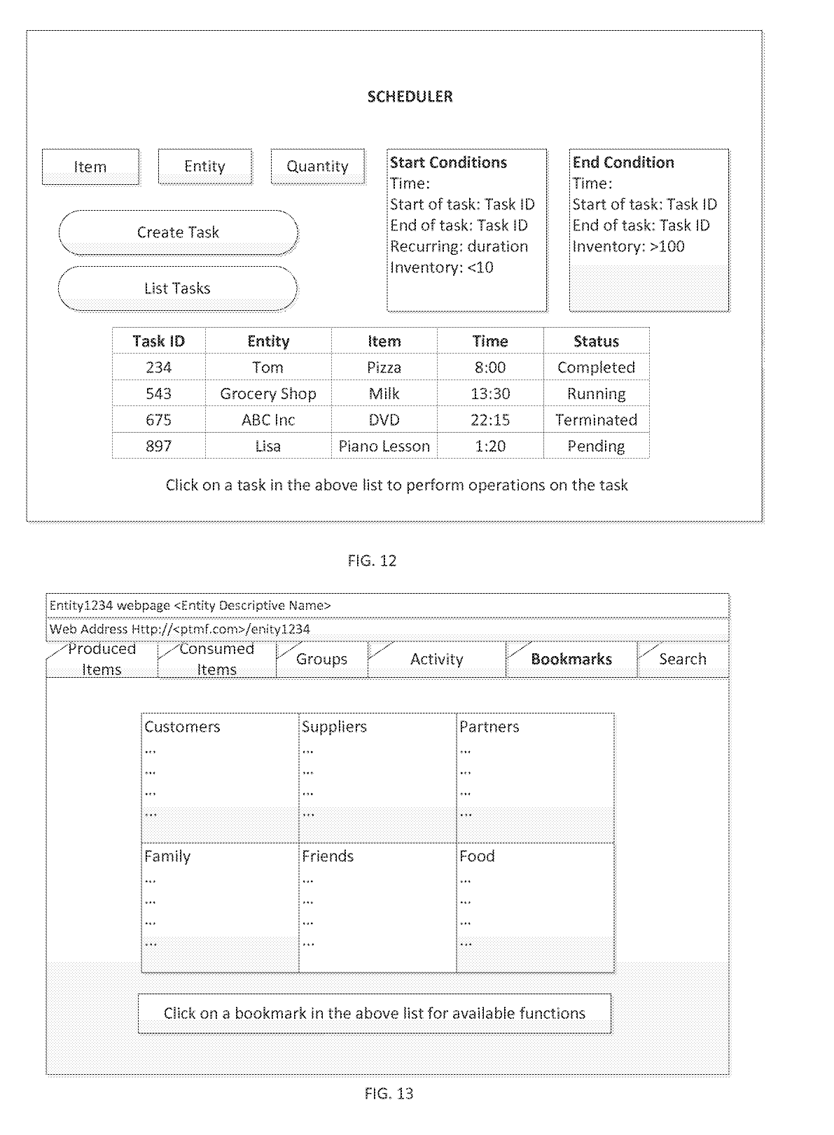

FIG. 12 shows a view of the Scheduler tab with means to schedule tasks. The tasks can be conditionally started and terminated. Multiple tasks can be chained and executed in series or they can run in parallel, as needed, to accomplish necessary results. The tab also contains a list of tasks. The user can check the status of these tasks and perform certain operations on these tasks, including cancelling or rescheduling.

FIG. 13 illustrates a view of the Bookmarks tab in which frequently accessed entities can be organized in a functionally meaningful manner. Normally, users interact with a few entities on a regular basis and this feature makes it more convenient for the user. The user can click on any entity list and further options are presented to interact with the selected entities.

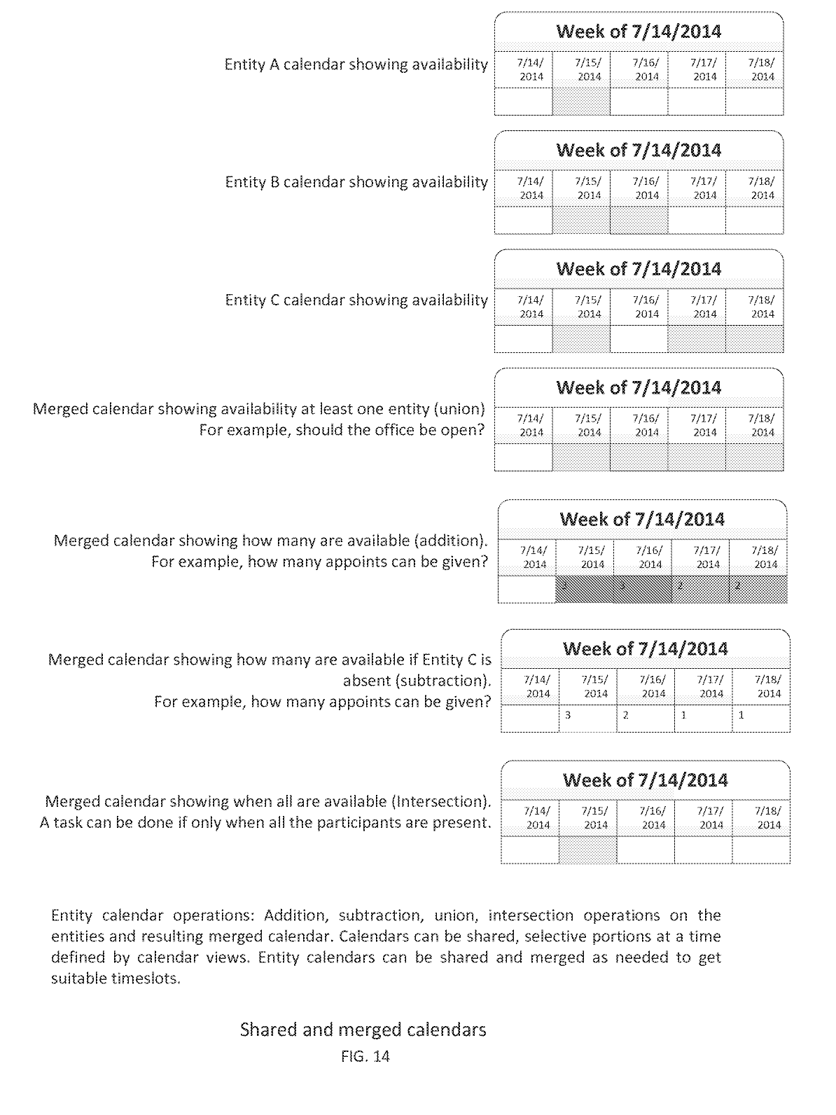

FIG. 14 shows an examples of the calendar uses. The calendar offers flexible and useful functionality to the users. It allows the creation of multiple views and entities can share specific views. Using the shared views, two or more entities can reserve timeslots, set up appointments, and schedule tasks. The calendar also allows addition, union, subtraction, and intersection operations between the calendars of two or more entities. The examples show some of the uses of these operations.

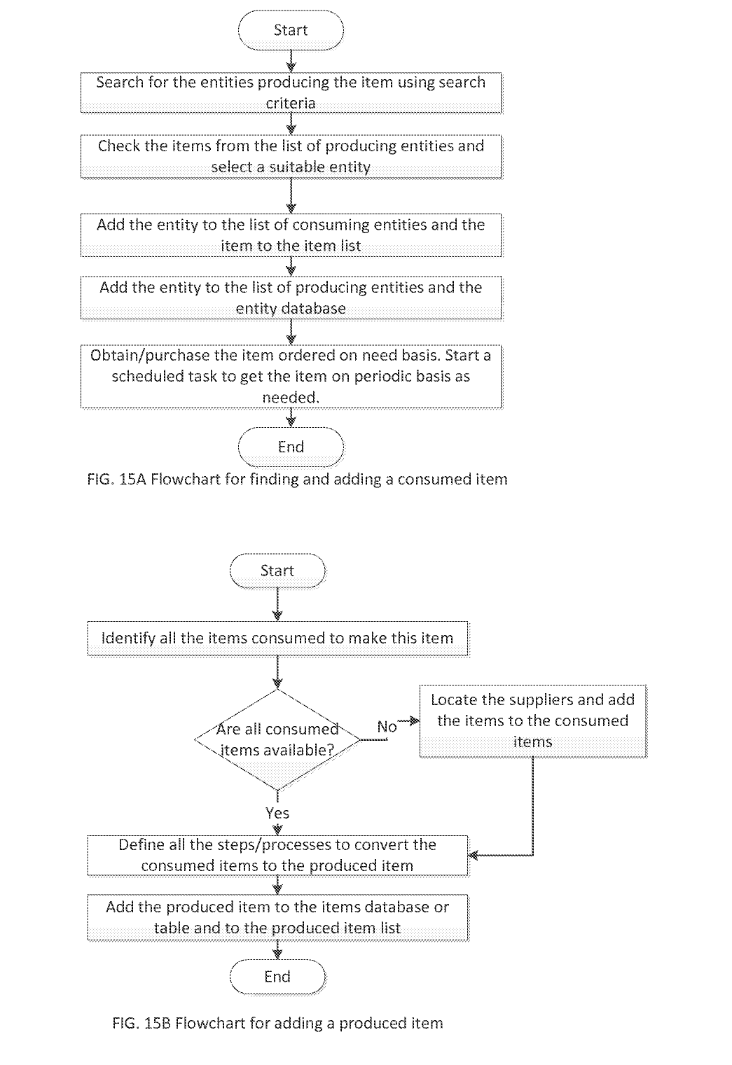

FIG. 15A shows a flow chart for adding a consumed item.

FIG. 15B shows a flow chart for adding a produced item.

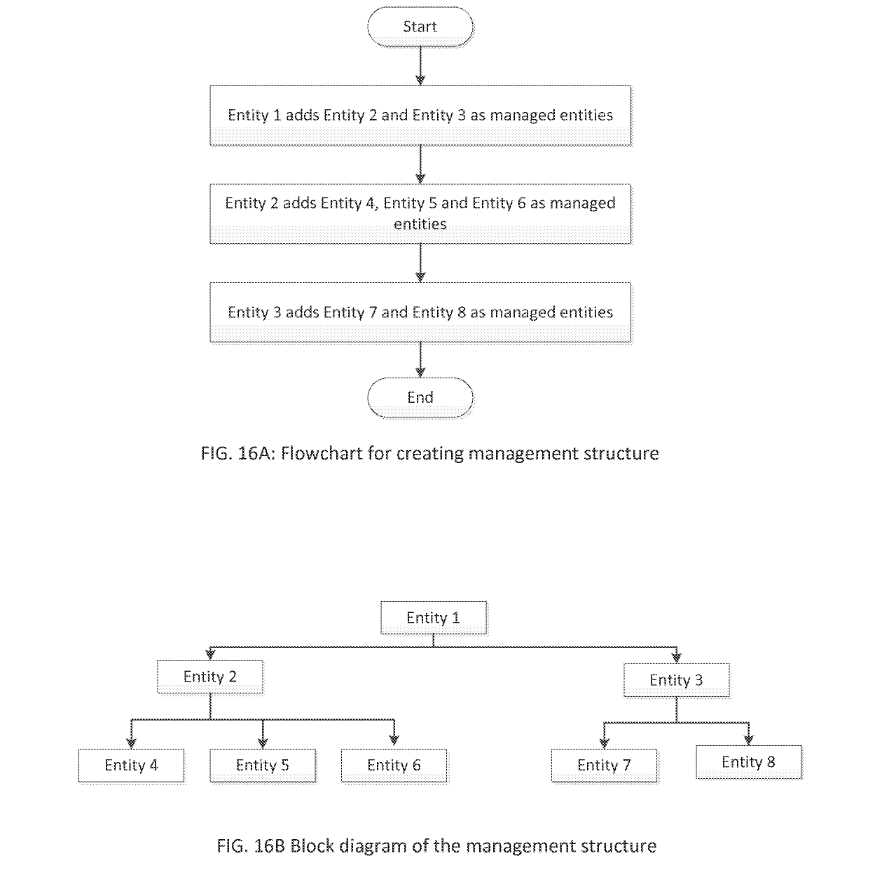

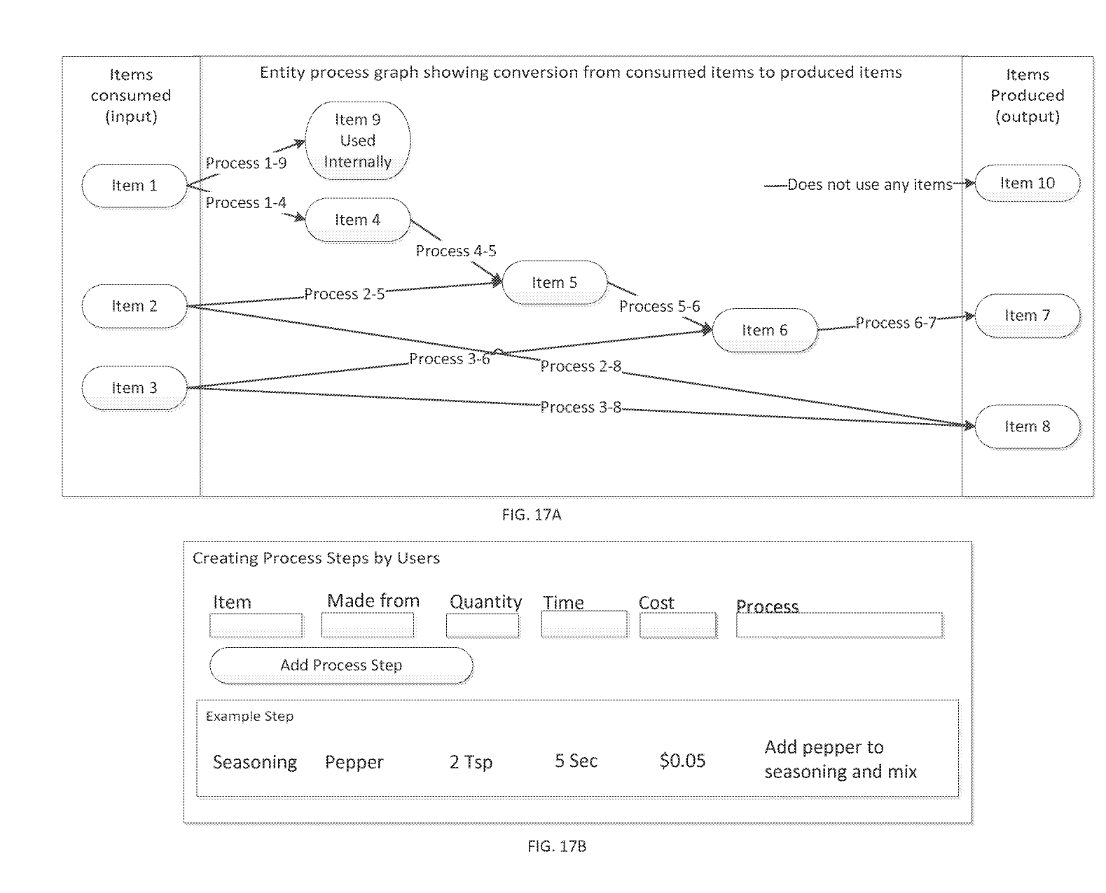

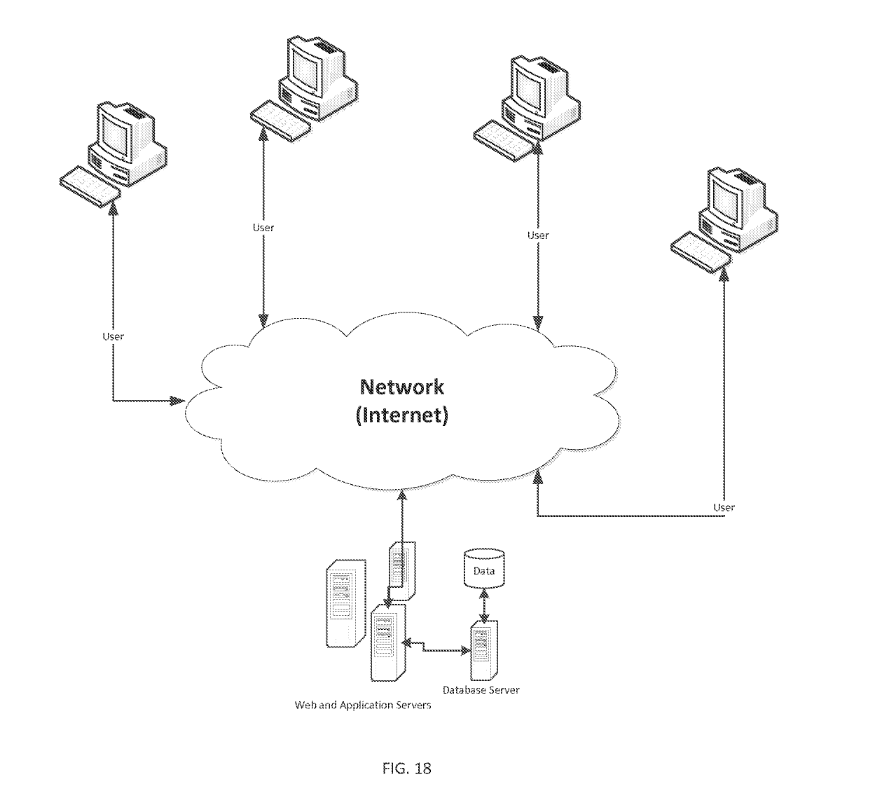

FIG. 16A shows how to setup managed entities to function like a management structure of a business or organization. FIG. 16B shows the resulting managed entity structure of 16A operations.

FIG. 17A is an exemplary view of an entity process graph showing conversion from the entity's inputs to its outputs or how consumed items are converted to produced entities within the entity's process. The graph nodes indicate the intermediate stages of the items in the conversion process and a process step is the process defined for an item undergoing from one stage to the next stage. These stages and process steps are defined by the entity. These may be multiple intermediate items produced before final produced items are produced. The system can traverse the process graph and compute item dependencies, process order, process time from any stage to any other stage, cost of the process, material requirements, etc. Users may be able to create and edit the process graph graphically or textually.

FIG. 17B shows how to create a process step for an item. Item is the target item, Made from is the item from which the target item is made. The target item may be made from several items which would be specified in different process steps. Quantity is the quantity of the Made from item to produce the target item. Time is the time for the process step,

Cost is the cost of this operation (step), and Process is the description/specification of this step. An example step is also shown.

FIG. 18 shows an exemplary system configuration. The system includes web and application servers and a database server connected to a network such as the Internet and the database server.

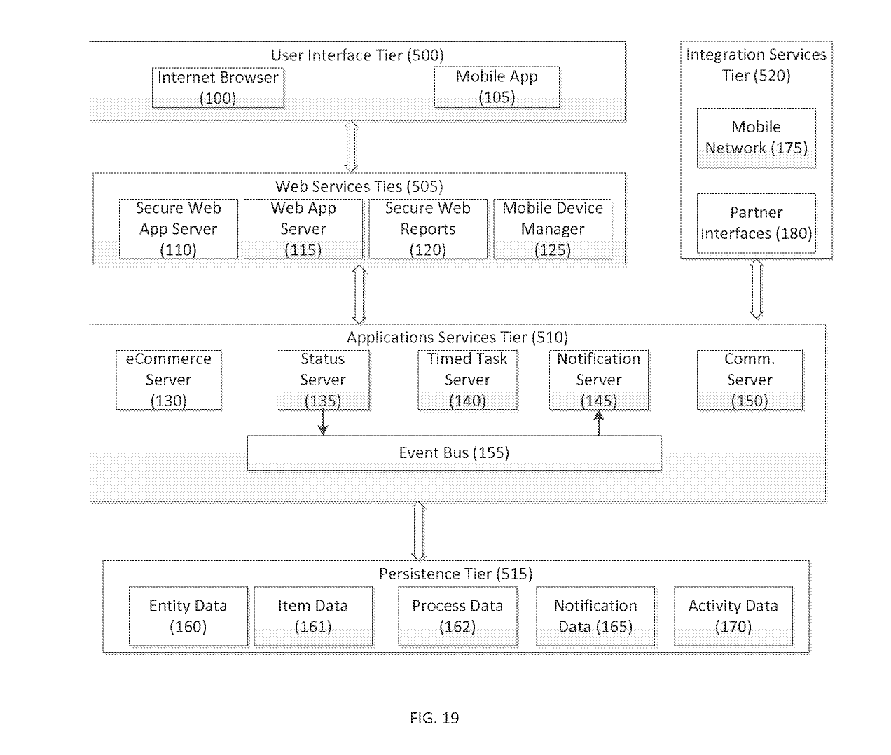

FIG. 19 depicts the high level system architecture. User Interface Tier 500 consists of standard internet browsers 100 and custom applications 105 for mobile and internet devices. These are the primary frontend components allowing communication between the entities and the system. The user interface tier communicates with Web Services tier 505 using HTTP/HTTPS protocol. Web Services Tier 505 hosts the Secure Web Application Server 110 that allows secure HTTPS connections to the Application Services Tier 510, the Web Application Server 115 that allows regular HTTP connection to the Application Services Tier, Secure Web Reports Server 120 that is used for report generation, Mobile Phone Locator 122 determines the current location of a mobile phone by interacting with mobile service providers and mobile device manager 125 that provides mobile user context for the rest of the components. The Web Services tier communicates with the Application Services tier 510 using XML/HTTP protocol. Optionally, surrounded by two firewalls, one restricting access from the internet, and the other restricting access to the application services tier, the system creates a demilitarized zone. This tier can be scalable independent of the rest of the tiers.

Application Services Tier 510 consists of Ecommerce Server 130 that allows secure financial transactions through external payment gateways using SOAP, Status Server 135 that handles the task management logic of the system with the help of Timed Tasks Server 140, Notification Server 145, Communications Server 150 and Event Bus 155. Accessible by the trusted servers of the web services tier, allowing access through XML over HTTP/HTTPS ports. This tier is computationally intensive and independently scalable.

Persistence Tier 515 allows for persistence of system data such as Entity Data 160, Item Data 161, Process Data 162, Notification Data 165, and Activity Data 170.

The Entity Data 160 contains tables with fields including entity id, name, description, location, produced and consumed items references, entity relationships, group references, calendar references and other related fields. The item Data 161 contains tables with fields including item id, name, description, producing and consuming entity references, cost, stock, units of measurements and other related fields. Process Data 162 contains tables with fields including process step id, target item, source item, process, process cost, process time, and other related fields. Access to the persistence tier is through JDBC protocol.

Integration Tier 520 hosts the Mobile Network 175 that allows connectivity with various mobile network providers and Partner Interfaces 180 that allows integration with third-party task management applications. The Integration tier communicates with Web Services tier using SOAP protocol.

Status Server 135 carries out the core logic of searching entities based on attributes whose values are time and location bound. In other words, every search may involve a time range, which defaults, for example, to a time range of begin-time=“now” and end-time=“now+15 minutes.” Optionally, a search may involve geographical location of an entity. Status Server also carries-out attribute updates by entities, which may be effective over a time-range, which defaults to begin-time=“now” and endtime=“now+15 minutes.” Temporal search of entities based on attribute values over a period of time is accomplished by in-memory indexing of attribute values over time-range. The indexing will be kept manageable and efficient by remembering time-ranges that are current and in the future. An attribute's value over past range will be removed at the time of update. At the time of entity attribute value update, status server will also check for any pending item requests for the entity. If there are any, the status server evaluates such item requests and if any of them results in a success, posts a notification event to the Event Bus 155 for further processing by Notification Server 145.

Timed Tasks Server 140 is an enterprise task scheduling server, supporting the status server for scheduling time-based notification tasks. When the timer for a scheduled task expires, timed task server makes a callback to Status Server 135 with enough information regarding the task. Status server then performs the task, which may result in evaluating a specific item request and potentially notifying the interested entity. Notifying the interested entity is accomplished by posting a notification event on the Event Bus 155.

Notification Server 145 picks up and processes notification events from the Event Bus 155. When the Event Bus is empty, the Notification Server stays idle. When a notification event gets successfully posted from the Event Bus, the Notification Server composes the notification message and sends out the notification message to the interested entity through Communications Server 150.

Communications Server 150 is used to deliver messages to the recipients through various communications channels, such as phone, fax or email.

Event Bus 155 is the communication channel between the Status Server and the Notification Server. Whenever Status Server 135 needs to send a notification to an interested entity, Status Server posts a notification event that has enough information about the message and the interested entity, to the Event Bus. Notification Server 145 picks up the notification event, constructs the notification message, and sends it to the Communications Server 150 for delivery.

Location Data 162 is a geographic information system (GIS) that indexes the items based on their location coordinates and allows searching of items relative to their geographical position.

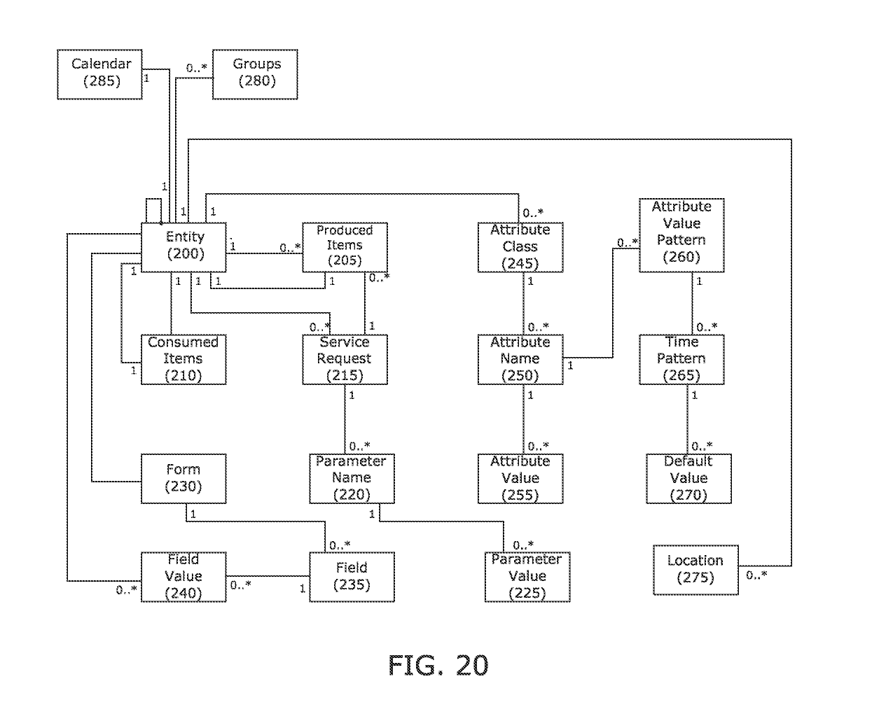

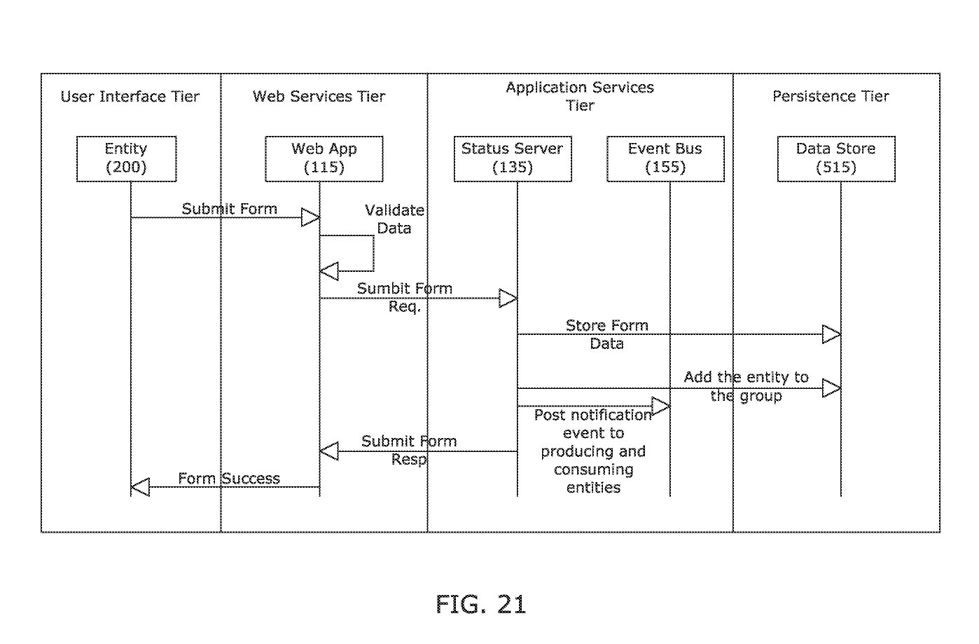

FIG. 20 depicts the logical data model of the entity. Entity 200 consists of a name and a set of attributes where each attribute is a name 250, value/s 255 pair where the value/s are over a range of time. The default attribute value/s may be specified using attribute-value-patterns 260. An entity may be associated with a location 275 that captures the geographical coordinates and address.

An entity may be associated with a collection of other entities known as produced 205 entities and consumed 210 entities. An entity may also be associated with forms 230 that allow interaction between the producer and the consumer. Forms are composed of zero or more form-fields 235. An entity may also be associated with item requests 215 that allow descriptions of items. The basic function of an item request is to identify matching items based on the item description.

Attribute Class 245 is used to classify attribute/value pairs of an entity into categories based on business or functional criteria. Attribute Name 250 contains the name and type of an attribute that can have zero or more attribute values associated with it. Attribute Value 255 is the actual value of an attribute over a period of time. Attribute Value Pattern 260 is organized by effective date and defines the default values for an attribute over a period as defined in a Time Pattern 265. For example, one can specify daily, weekly or monthly default values that can be used repetitively.

Time Pattern 265 specifies the time pattern, such as daily, weekly or monthly. The Default Values 270 thus specified are used repeatedly daily, weekly or monthly respectively.

The values of an attribute can be specified by the producing entity indirectly through a default value pattern or directly by overriding the default value. The consumer can view the effective value in real time.

Default Value 270 specifies the default value of an attribute over a period of time. If an actual value of an attribute for a given period of time is absent, the system will use the default value, if any, that is applicable for the attribute over that specific period of time.

Location 275 captures the address and geographical coordinates of entities allowing geographic location based search. The geographical coordinates of an address can be obtained by querying public geographical information systems (GIS). Items can be searched by considering user's current location or a specified location. The search results depict services, products, events which are closer to the specified location. A location request can be launched by the Mobile Phone Locator 122 to figure out the current location information of a particular user. Mobile Phone Locator sends a request to the user's mobile or mobile network which in turn responds back with its location. The location can be a close approximation of user's mobile geographical position as detected by a satellite or cell tower. Once the response is received, the system interacts with the location data (GIS) 162 to search for needed items.

Produced Items 205 associates two entities, one as producing entity and the other as an item produced. The relationship between the producing entity and the item may be effective over a period of time. Producing entity can specify when the item is available for consumption. Producing entity can keep track of who is interested in the item produced.

Similarly, Consumed 210 associates two entities, one as a consuming entity and the other as item. Consumed is used to determine and generate the appointment calendar of the consumer and the delivery schedule of the producer. A Calendar 285 with multiple views is used by the entity, each view is designed to share with a selective list of entities or Groups 280. The calendar functionality also allows merging of multiple calendar views from different entities by performing operations such as addition, union, intersection, subtraction on the times lots of the calendars. Any change such as cancellation of consumption is notified to the consuming entity and/or the producing entity and the calendars of the consuming entity and the producing entity may reflect the change automatically. The entity may organize other entities into Groups 280 by specifying privileges, calendar views, etc.

Item Request 215 is a named piece of Parameter Name 220, Value 225 pairs that defines an entity's item request. An item request can be used to search for a list of matching items that an entity is interested in. It is also used to notify interested entities based on the conditions specified in the item request.

Item Request can also be used to specify items of interest such as a request for proposal (RFP) to which interested producing entities can respond.

Form 230 is a named collection of Field 235, Value 240 pairs that defines a form associated with an entity. Form has a specified group, so that every entity that submits the form gets added to that group. Form also can be either published or not. Multiple forms belonging to a single entity are ordered for presentation purposes using the order attribute of the form. The System provides a library of predefined forms for user convenience.

Field 235 is a collection of attributes such as Label, FieldType, Input, Password, Inventory and Order that are used to define a Form Field. Multiple fields belonging to a single form are ordered for presentation purposes using the order attribute of the field.

Field Value 240 associates the value/s entered by an entity with the field belonging to a form.

FIG. 21 shows submit form mechanism. When an entity 200 submits a form through the web, the web application 115 validates the form data and submits the form data to the status server 135. Status server stores the form data in the data store 515, adds the submitting entity to the group associated with the group of the form and posts a notification event for the entity that owns the form in context.

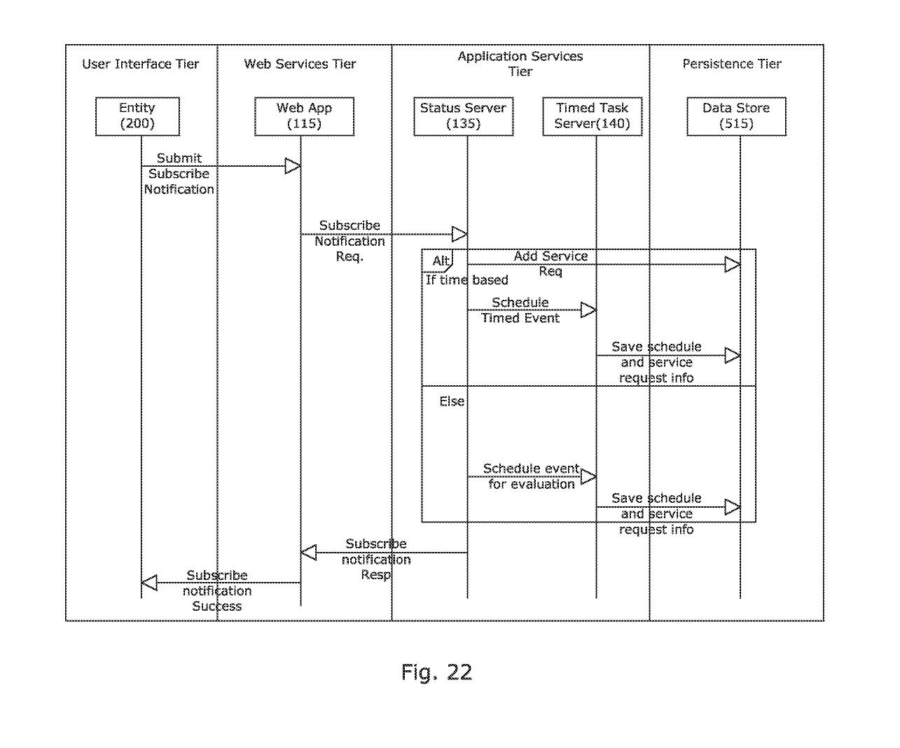

FIG. 22 shows subscription for notification. When entity subscribes for notification through the web, the status server 135 does the following:

1. Creates an item request 215 on behalf of the subscribing entity and saves it in the data store 515.

2. Checks to see if the item request is time based. If true, schedules a timed event in the Timed Tasks Server 145 to evaluate the item request at a specified time in the future.

Else, the server figures out the next change in each of item request's attribute's default value in the near future, and schedules a timed event in the timed tasks server to evaluate the item request at that specific time in the future.

The item requests are evaluated whenever an entity manually updates any attribute of an item. Apart from that, item requests must also be evaluated whenever an attribute change happens due to the default load pattern. To handle the automatic attribute change scenario, every time an item request is added, a timed task to evaluate the item requests at the next automatic attribute change is also scheduled.

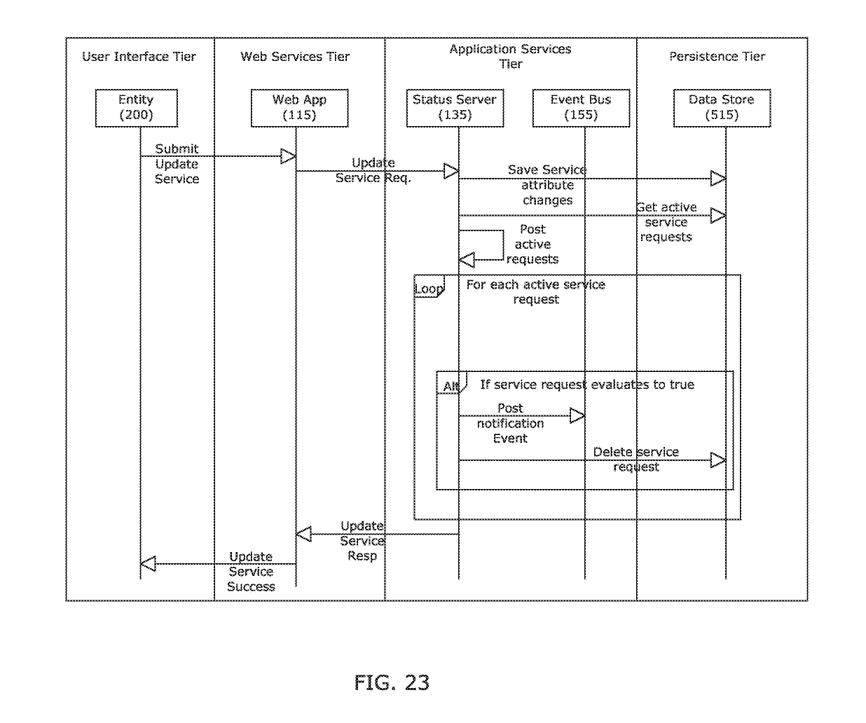

FIG. 23 shows Update Item mechanism. When an entity updates any of its produced and published entity's attribute value/s, the status server does the following:

1. Saves the attribute value change in the data store 515.

2. Checks to see if there are any pending item requests associated with the produced entity.

3. For each pending item request, the status server does the following:
A. Evaluate the item request
B. If the evaluation results in true, then post a notification event on the event bus 155 and delete the item request from the produced entity.

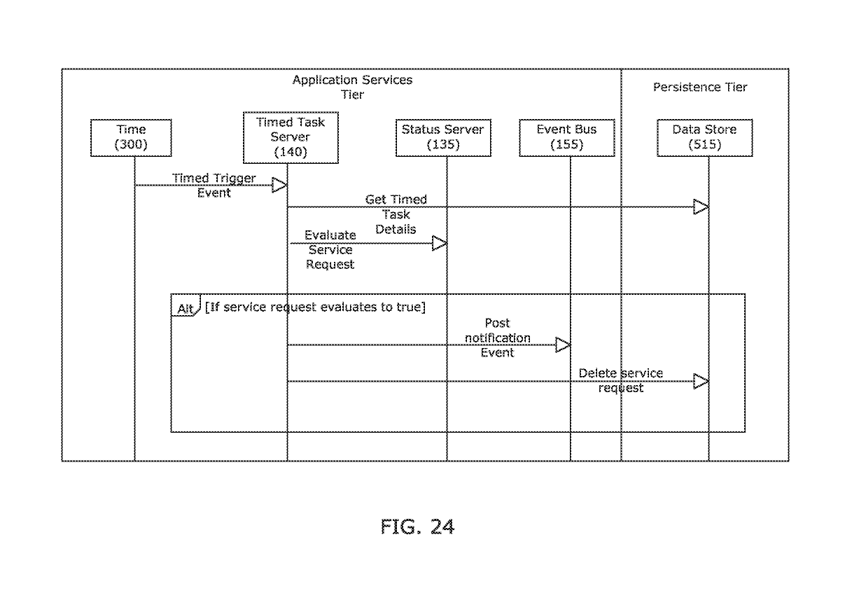

FIG. 24 shows the Triggering Mechanism for Timed Tasks. When the timed task server 140 triggers a previously scheduled timed event, the timed task server calls back Status

Server 135 to evaluate the relevant item request. Status Server evaluates the item request and if the evaluation results in true, posts the notification event on the event bus 155 and removes the item request from its associated produced item.

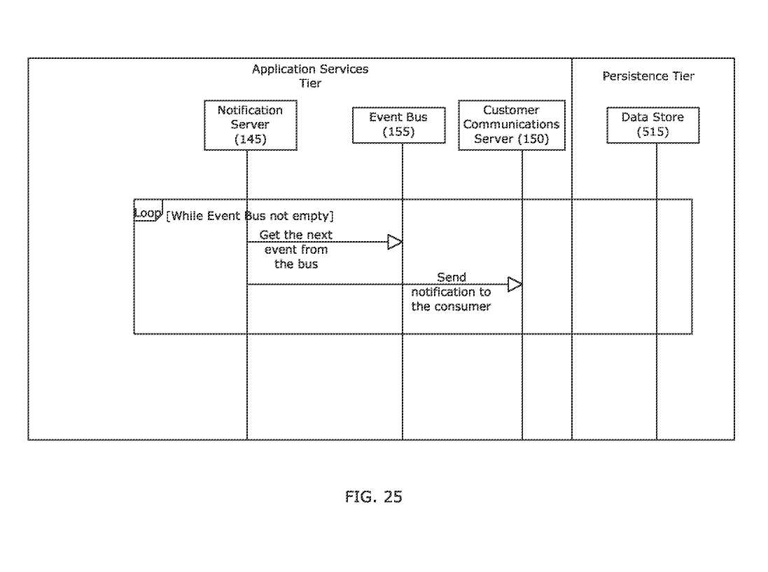

FIG. 25 shows the Event Bus Processing. When a notification event gets posted on the

Event Bus 155, Notification Server 145 picks up the event, constructs the relevant message and sends it to the Communications Server 150 for delivery to the interested entity. The notification event contains the source entity, the destination entity and other relevant notification data.

What is claimed is:

1. An adaptable application platform system useful for adapting to people's day-to-day tasks, comprising:
a network;
a plurality of user computing devices, wherein each of the plurality of users computing devices is connected to the network;
a data store; and
a server computing device connected to the network and the data store, the server computing device executing instructions configured to:
present a user interface to the user computing devices, wherein the user interface allows a user to create a plurality of software entities, each entity of the plurality of software entities stored on said data store and comprising:
a unique identification, a computational representation of a single person, a group of people, a business, an organization, or an institution,
a first list of one or more produced items, and a second list of one or more consumed items, each item representing a good or a service;
wherein said user interface further comprises:
a matching interface for connecting an entity of a first user with an entity of a second user; and
a process interface for allowing a user to create a plurality of process steps, wherein each step of the plurality of process steps comprises a target item, a source item, optionally a quantity of the source item, a processing time, and a description;
the instructions further configured to:
construct a process graph from the plurality of process steps;
evaluate the quantities of the source items for each step of the plurality of process steps within the process graph;
compute the time needed to complete the target items based on the processing times, wherein each target item can comprise a produced item or one or more intermediate items; and
compute costs assigned to each process step within the plurality of process steps within the process graph by evaluating the quantities of the source items and the time needed to complete the target items.

2. The adaptable application platform system of claim 1, wherein the matching interface further comprises a search interface, wherein the search interface comprises a plurality of search options, the search options comprising:
an item from the first lists;
an item from the second lists;
an entity by interest; or
an entity by name;
thereby allowing a user to find relevant results.

3. The adaptable application platform system of claim 2, wherein the search interface further comprises a means for selecting either goods or services when an item from the first lists or an item from the second lists is selected as a search option.

4. The adaptable application platform system of claim 1, wherein the process interface further comprises a means for assigning an entity to each process step, thereby allowing a user to link a produced item of the entity to the process step.

5. The adaptable application platform system of claim 3, wherein the instructions executed by the server computing device further comprise a task scheduling agent, whereby the task scheduling agent is configured to schedule a time for a produced item supplied by a first entity to be consumed as a consumed item by a second entity.

6. The adaptable application platform system of claim 5, wherein the task scheduling agent further comprises means for specifying task start conditions and task end conditions.

7. The adaptable application platform system of claim 1, wherein each entity for the plurality of software entities further comprises a calendar, wherein the user interface is configured to allow a user to configure an entity's calendar to be selectively shareable with at least one other entity.

8. The adaptable application platform system of claim 7, wherein the user interface is configured to allow a user to perform Boolean operations (e.g., AND, OR, XOR, SUBTRACT) on an entity's calendar with at least one other entity.

9. An adaptable application platform system useful for adapting to people's day-to-day tasks, comprising:
a data store containing data for:
a plurality of entities, each entity of said plurality of entities comprising a computational representation of a single person, a group of people, a business, an organization, or an institution;
a server computer coupled to the data store and executing instructions configured to:
present a user interface to a plurality of communications devices connected to a network, wherein the user interface is configured to allow a user to create a plurality of entities;
receive a request from a first user via the user interface to create a workflow comprising a plurality of process steps, wherein each step of the plurality of process steps comprises a target item, a source item, a processing time, and a description;
evaluate the quantities of the source items for each step of the plurality of process steps within the workflow;
compute the time needed to complete each of the target items, wherein each target item can comprise a produced item and one or more intermediate items;
compute costs assigned to each process step within the plurality of process steps within the process graph by evaluating the quantities of the source items and the time needed to complete the target items.

10. The adaptable application platform system of claim 9, wherein the instructions executed by the server computer are further configured to execute the workflow to create a produced item.

11. The adaptable application platform of claim 9, wherein the instructions executed by the server computer are further configured to:
receive a request from a second user via the user interface to search for one of a produced item, a consumed item, an entity by interest, or an entity by name;
identify at least one relevant result related to the second user's request; and
present, via the user interface, the at least one relevant result to the second user.

12. The adaptable application platform system of claim 11, wherein the user interface further comprises an option for selecting whether the produced item or consumed item is a produced good or service or a consumed good or service.

13. The adaptable application platform system of claim 9, wherein the data store further comprises:
a plurality of tasks, each task of said plurality of tasks associated with at least one entity and comprising a computational representation of a produced item or a consumed item; and
a calendar comprising availability information related to each task associated with each entity;
wherein the instructions executed by the server computing device are further configured to:
receive a request from the first user via the user interface to create a first task associated with a first entity, the first task comprising a computational representation of a produced item;
receive a request from a second user via the user interface to create a second task associated with a second entity, the second task comprising a computational representation of a consumed item;
determine whether the second task can be completed by the first task according to the availability information related to the first and second tasks;
if the second task can be completed by the first task, present the first task to the second user via the user interface and present the second task to the first user via the user interface such that the first user and second user can complete the first task and the second task.

14. The adaptable application platform system of claim 13, wherein the calendar further comprises a calendar for each entity of the plurality of entities, wherein the user interface is configured to allow a user to configure an entity's calendar to be selectively shareable with at least one other entity.

15. The adaptable application platform system of claim 9, wherein the user interface is configured to allow a user to create a complex entity by aggregating items of a first entity of the plurality of entities and items of a second entity of the plurality of entities, wherein the workflow is associated with the complex entity.

16. The adaptable application platform system of claim 15, wherein a first step of the plurality of process steps is performed by the first entity and a second step of the plurality of process steps is performed by the second entity.

17. The adaptable application platform system of claim 1, wherein the process graph can be shared or traded with other entities, whereby a process can be replicated and customized as needed and can also be used as a process training tool.

18. The adaptable application platform of claim 9, wherein the instructions executed by the server computer are further configured to schedule a time for a produced item supplied by a first entity to be consumed as a second item by a second entity.

19. The adaptable application platform system of claim 18, wherein the user interface further comprises options for specifying conditions for the produced item supplied by the first entity to be consumed as the second item by the second entity.

20. An adaptable application platform system useful for adapting to people's day-to-day tasks, comprising:
means for storing data for:
a plurality of entities, each entity of said plurality of entities comprising a computational representation of a single person, a group of people, a business, an organization, or an institution;
a plurality of tasks, each task of said plurality of tasks associated with at least one entity and comprising a computational representation of a produced item or a consumed item; and
a calendar comprising availability information related to each task associated with each entity; and
means for presenting a user interface to a plurality of communications devices connected to a network;
means for creating entities via the user interface;
means for creating tasks via the user interface;
means for connecting entities associated with related tasks according to the availability information such that the tasks may be completed; and
means for creating a process graph comprising a plurality of tasks via the user interface.
